(19) United States
(12) Patent Application Publication
(10) Pub. No.: US 2015/0065688 A1
(43) Pub. Date: Mar. 5, 2015

(54) SURFACES HAVING NANOPARTICULATE LAYERS AND ASSEMBLY AND USE THEREOF

(71) Applicants: Regina Ragan, Irvine, CA (US); Sri Sivakumar, Kanpur (IN); Raj Ganesh S. Pala, Kanpur (IN); Arun Prakash Upadhyay, Kanpur (IN)

(72) Inventors: Regina Ragan, Irvine, CA (US); Sri Sivakumar, Kanpur (IN); Raj Ganesh S. Pala, Kanpur (IN); Arun Prakash Upadhyay, Kanpur (IN)

(21) Appl. No.: 14/474,035

(22) Filed: Aug. 29, 2014

Related U.S. Application Data
(60) Provisional application No. 61/873,336, filed on Sep. 3, 2013.

(51) Int. Cl. B01J 20/289; C02F 1/30; C25B 3/04; C25B 1/04; B01J 23/52; B01J 20/32

(52) U.S. Cl. CPC B01J 20/289; B01J 23/52; B01J 20/3295; C25B 3/04; C25B 1/04; C02F 1/30; C02F 2101/10
USPC 530/367; 548/109; 205/440; 205/628; 210/748.09

(57) ABSTRACT

A method for generating layered structures is disclosed. The method comprises reacting an azide-functionalized material with an alkyne-functionalized material, one of which can be a nanoparticle or a microparticle and the other can be a substrate or another nanoparticle or microparticle. The method also includes generating layered structures having multiple layers which can be built up in multiple azide-alkyne reaction steps.

### RELATED APPLICATIONS

This application claims the benefit of U.S. Provisional Application 61/873,336, filed on Sep. 3, 2013, the disclosure of which is incorporated by reference in its entirety, and is related to Indian Provisional Patent Application No. 2169/DEL2013, filed at the Indian Patent Office on Jul. 19, 2013, the disclosure of which is incorporated herein and made a part of the disclosure of the present application.

### STATEMENT REGARDING FEDERAL FUNDING

Embodiments of the present disclosure were made with Government Support under contract numbers NSF-CHE-0748912, NSF-CMMI-1101074 and NSF-CBET-0731349 awarded by the National Science Foundation. The Government has certain rights in this invention.

### TECHNICAL FIELD

This disclosure relates to surfaces having Nanoparticulate layers including their production and use. In particular the surfaces can include those which have tailored layers and the layers can be multiple layers, such as those built up in a step-wise fashion.

### BACKGROUND

Monolayers and multilayers of nanoparticles have application in areas of biosensing devices, drug delivery vehicles, photonics, spintronics along with many applications in electrical and optical devices and in other areas as well. For example, biosensors employing a principle of Localised Surface Plasmon Resonance (LSPR) not only can use gold or silver nanoparticles but can also use nanostructures developed by depositing a noble metal into gaps created by spreading of polystyrene, silica or other similar substrates.

Some techniques for fabricating nanoparticles assemblies can include application of molecular interaction (such as van der Waals forces, electrostatic interaction, hydrogen bonding), DNAs-assisted assemblies, external fields (such as electric field, capillary forces, etc.), covalent interactions. However, processing can be difficult with serious challenges such as stability at different process conditions (e.g. pH, temperature etc.), lack of control over multilayer formation, equipment requirements, cost of reagents and interfacial operating conditions. Product defects such as non-homogeneous ordering of nanoparticles and appearance of void areas between the nanoparticles aggregates within a layer can also cause problems with the resulting product. In some situations, low yield, unwanted by-products, extreme process conditions that may damage substrates or nanoparticles can become issues. Accordingly, a process for reliably and cost-effectively making monolayer and/or multilayers of nanoparticles on a selected substrate is desired.

### SUMMARY OF THE INVENTION

A method for generating layered structures, including layered structures comprising nanoparticles and microparticles, reliably and cost-effectively is desired.

Accordingly, in a first aspect, a method for generating layered structures is provided, the method comprising reacting an azide-functionalized material with an alkyne-functionalized substrate to form a layer on the substrate, wherein the reaction couples the azide-functionalized material to the alkyne group of the alkyne-functionalized substrate, wherein the azide-functionalized material is a nanoparticle or a nanoparticle.

In a second embodiment, a method for generating layered structures is provided, the method comprising reacting an alkyne-functionalized material with an azide-functionalized substrate to form a layer on the substrate, wherein the reaction couples the azide-functionalized material to the alkyne group of the alkyne-functionalized substrate, wherein the azide-functionalized material is a nanoparticle or a microparticle.

### BRIEF DESCRIPTION OF THE DRAWINGS

Preferred embodiments will be described with reference to certain drawings. The drawings described are only schematic and are non-limiting. In the drawing, the size of some of the elements may be exaggerated and not drawn to scale for illustrative purposes.

FIG. 1 is a schematic diagram for nanoparticle assembly on substrates.

FIGS. 2a and b demonstrate the contact angle of water on substrates.

FIG. 3 is an FTIR of alkyne functionalized silica nanoparticles.

FIG. 4 is an FTIR of azide functionalized silica nanoparticles.

FIG. 5 is an FTIR of azide functionalized gold nanoparticles.

FIG. 6 is an FTIR of alkyne functionalized gold nanoparticles.

FIG. 7a-d are SEMs of functionalized nanoparticles on substrate.

FIG. 8a-h are SEM images of various monolayers on substrates.

FIG. 9a-d are SEMs of different nanolayer combinations on substrate.

FIG. 9e is an SEM of a bilayer of gold nanoparticles.

FIG. 10a-b are SEM images of different nanolayer combinations on substrate.

FIG. 11 is a voltammetric profile of Au on Si substrate in 0.1 M NaOH and 2.5 M MeOH at different scan rates.

FIG. 12 is a voltammetric profile of Au on Si substrate in 0.1 M NaOH and 0.1 M MeOH at different scan rates.

FIG. 13 is a voltammetric profile of Au on Si substrate in 0.1 M NaOH at 50 mV/s scan rate.

FIG. 14 is a voltammetric profile of Au on Si substrate in 2.5 M MeOH at 50 mV/s scan rate in varying concentrations of NaOH.

FIG. 15 shows the results of a stability analysis of Au on Si substrate in 0.1 M NaOH and 0.1 M MeOH at 50 mV/s scan rate.

FIG. 16 is an SEM of gold nanoparticle monolayers after cyclic voltammetric analysis.

FIG. 17a-d show cyclic voltammetric results for a stability analysis of nanoparticle layers on various substrates.

FIG. 18 shows the voltammetric behavior of Au on Si substrate in 0.1 M NaOH at 50 mV/s scan rate.

FIG. 19a-d are SEM images of gold nanoparticle monolayers on various substrates after methanol oxidation.

FIG. 20a-d shows the results of electrochemical water splitting.

FIG. 21a-d show the results of photochemical degradation of Rhodamine B.

FIG. 22 is a schematic diagram of a dye degradation mechanism.

FIG. 23 is a schematic for bioconjugation of fluorescein isothiocyanate-avidin with biotin.

FIG. 24a-c are bright field and fluorescence images of azide-functionalized silica particle monolayers and of bioconjugated silica particles on glass substrate.

### DETAILED DESCRIPTION

In the following description, numerous specific details are set forth to describe various specific embodiments disclosed herein. One skilled in the art, however, will understand that the presently described technology may be practiced without all of the specific details discussed below. In other instances, well known features have not been described so as not to obscure the invention.

Layered structures, in various embodiments, can include layers comprising/consisting/consisting essentially of microparticles or nanoparticles, layers comprising/consisting/consisting essentially of chemical entities, single layers, multiple layers, layers built-up a single layer at a time, layers built up on a surface, and combinations thereof.

Various approaches or methods and techniques can be used for nanoparticle assemblies which can rely upon molecular interaction including, for example van der Waals forces, electrostatic interaction, hydrogen bonding, halogen-bonding, DNAs-assisted assemblies, etc.; or external fields, for example electric field, capillary forces, etc.: or other principles/techniques such as dithiocarbamate bond, Langmuir Blodgett, spin-coating, Doctor Blade, etc.

Preferred methods of production can exhibit good stability at different conditions (such as pH, temperature, pressure, chemical environment, etc.), good control over the layers being formed, good control of the formation of layers, and a reduced need for special equipment.

In some embodiments, aspects of existing techniques, such as Langmuir Blodgett, Doctor Blade, wire-wound rod coating etc., can be incorporated into the methods described herein.

A highly preferred method can have one or more characteristics of:
1. Nanoparticle/microparticle monolayers and tailored multilayers being very stable in different conditions (such pH, Temperature, applied voltage, etc.)
2. Production under mild conditions such as where during production, one or more of the conditions can be as follows: pH between about 4 to 8 or 3 to 9 or 2 to 10; temperature less than about 25° C., 80° C., 100° C., 110° C., 130° C., 150° C., 170° C., or 200° C.; biocompatible conditions, and the like.
3. Control over the multilayer formation.
4. Preparation of multilayers of different nanoparticles/microparticles to make heterostructures including, for example, semiconductor (CdSe, TiO₂, etc.), metal (gold, platinum, silver, other nobel metals, etc.) and/or dielectric nanoparticles (silica, polystyrene) in alternating layers, or layers of semiconducting/dielectric or metal/dielectric core shell structures and combinations thereof. In some embodiments, the components can be determined, for example, by composition and size of nanoparticles in the layers desired.
5. Preparation of nanoparticle/microparticle monolayers and tailored multilayers on a variety of supports/substrates using methods disclosed herein. In some embodiments, the multilayers can be tailored to achieve particular geometry and/or composition of nanoparticles and number of layers. Depending on application—solar, plasmonic or catalytic—different supports/substrates can be used.
6. Generation of materials suitable for use in catalysis, separations or other applications, and use in various different fields including hydrogen generation via photocatalytic water splitting, biosensing, water purifications, electrochemical applications, photonic crystals applications etc.

As used herein, the word “nanoparticle” can include particles having a size of in the microparticle range or less than about 1000 nm, or less than about 500 nm, or less than about 200 nm, or less than about 100 nm, or less than about 50 nm, or less than about 20 nm or less than about 10 nm. In some embodiments, a nanoparticle can include particles having a range of sizes of about 200 to about 1000 nm, or about 50 to about 500 nm, or about 50 to about 200 nm, or about 10 nm to about 100 nm, or about 10 nm to about 50 nm. In some portions of this disclosure, a “nanoparticle” can refer to a particle that can also be called a “microparticle” as described herein.

As used herein, the word microparticle can include particles having a size of less than about 100 um, or less than about 50 um, or less than about 20 um, or less than about 10 um, or less than about 5 um, or less than about 2 um, or less than about 1 um. In some embodiments, a microparticle can include particles in the range of about 2 to about 100 um, or about 1 to about 50 um, or about 2 to about 50 um, or about 5 to about 50 um, or about 20 to about 200 um, or about 20 to about 100 um, or about 50 to about 200 um. In some portions of this disclosure, a “microparticle” can refer to a particle that can also be called a “nanoparticle” as described herein.

In one embodiment, a surface can be functionalized with an alkyne, followed by a first layering by exposure to and reaction with an azide-functionalized material, which can be followed by a second layering by exposure to and reaction with an alkyne-functionalized material, which can be then followed by a third layering by exposure to and reaction with an additional azide-functional material. Operation can continue with additional layerings by alternating steps of exposure to and reaction with alkyne-functional material and azide-functional material.

In another embodiment, a surface can be functionalized with an azide, followed by a first layering by exposure to and reaction with an alkyne-functionalized material, which can be followed by a second layering by exposure to and reaction with an azide-functionalized material, which can be then followed by a third layering by exposure to and reaction with an additional alkyne-functional material. Operation can continue with additional layerings by alternating steps of exposure to and reaction with azide-functional material and alkyne-functional material.

In some embodiments, the process can be stopped after the first layering. In some embodiments, the process can be stopped after the second layering. In other embodiments, the process can be stopped after a third, fourth, fifth, sixth, seventh, eighth, ninth, tenth, eleventh to fortieth or higher layering step.

In some embodiments, the azide-functional materials can all be the same or related material. In some embodiments, each step of exposure to and reaction with an azide-functional material can be with a different azide-functional material. In some embodiments, two, three, four, or more steps can utilize the same or related azide-functional material.

In some embodiments, the alkyne-functional materials can all be the same or related material. In some embodiments, each step of exposure to and reaction with an alkyne-functional material can be with a different alkyne-functional material. In some embodiments, two, three, four, or more steps can utilize the same or related alkyne-functional material.

In some embodiments, one or more alkyne-functional materials can be an alkyne-functional nanoparticles. In some embodiments, one or more azide-functional materials can be an azide-functional nanoparticles.

In some embodiments, suitable nanoparticles can be gold, silica, or other metallic, ceramic, or other materials. In some embodiments nanoparticles can be a composition of more than one metal, or more than one ceramic, or a ceramic and a metal such as gold-coated silica.

In some embodiments, an organic molecule or functional group can be functionalized with an azide or an alkyne group. In some embodiments, suitable organic molecules can include those having biological activity, such as biotin, avidin, protein biomarkers, DNA or RNA, enzymes, etc.) In some embodiments, suitable organic molecules can include amine groups, carboxyl groups, thiol, siloxane chemistries, hydroxyl, ammonium, methyl, acetyl, alkyl, alkenyl, alkynyl, phenyl, benzyl, etc., either alone or in combination.

Suitable organic molecules or functional groups or nanoparticle can include those having use as a marker (fluorescence such as fluorescein isothiocyanate (FITC), rhodamine isothiocyanate (RITC) or magnetic nanoparticles such as iron oxide and cobalt, etc.) or can be linked to those having use as a marker, as well as combinations of these molecules/groups/nanoparticles, both with and without marker properties and/or marker linking properties.

### Reactions

In various embodiments, copper (I)-catalyzed azide alkyne cycloaddition can be used for the reaction connecting a monolayer reagent to a substrate or a previously deposited monolayer.

### Substrates

Suitable substrates can include various materials including ceramics, glasses and metals. Examples of materials can include silicon (including, but not limited to doped and undoped forms of whatever size and purity, including, for example forms with group III and group V dopants such as boron, arsenic, phosphorus, antimony, aluminum, gallium, indium, thallium, ununtrium, bismuth and ununpentium as well as dopants from other groups and combinations of these dopants which can be used with silicon), titania (including but not limited to those of various crystal forms and various degrees of purity, such as those having tetragonal, orthorhombic, monoclinic, cubic forms and includes rutile, anatase, TiO₂(B), brookite, hollandite-like, ramsdellite-like, α-PbO₂-like, baddeleyite-like, cotunnite (PbCl₂)-like, OI forms and combinations thereof), indium tin oxide (ITO) (including but not limited to those of various compositions and ratios of In₂O₃ and SnO₂, electrical conductivity and optical transparency, as well as combinations of these), glass (including but not limited to soda-lime glass, fused silica glass, borosilicate glass, lead-oxide glass, aluminosilicate glass and oxide glass (such as comprising alumina and germanium oxide), and variations and combinations thereof) and stainless steel (including, but not limited to 200, 300 and 400 grades of stainless steel, such as 201, 275, 301, 302, 303, 304, 305, 308, 309, 310, 312, 316, 321, 330, 347, 350, 355, 405, 409, 410, 416, 420, 430, 431, 439, 440, 441, 446, 450, 455, 465, 475, and other types of stainless steels such as Alloy 10, Alloy 20, Alloy 30, Alloy 40, including special grades such as “A”, “B”, “C”, “L”, “LN”, “H”, “BQ”, “S”, “UF”, “DDQ” grades as well as hardened and unhardened forms and variations on the compositions and crystal forms of these forms and alloys.) In some embodiments, the substrate can be crystalline, amorphous or metallic. In some embodiments, ceramic materials can be oxides or nitrides.

In some embodiments, the surface structure of the substrate can be nominally (substantially) flat or nanopatterned. Examples of nanopatterning can include multilayered structures in the form of periodic lines, rectangles, squares, or other geometries.

### Uses

Layered and multilayered nanostructures, including nanoparticles monolayers and multilayers, can have properties useful in reactions, separations, and other areas, and can be used in the energy sector, for sensing applications, for water purification, for data storage, etc. In some embodiments, the layered and multilayered nanostructures can be used for catalysis or for separations, and can be used in multiple fields such in hydrogen generation via photocatalytic water splitting, in biosensing, in drug delivery, and photonics, and spintronics, in water purifications, in electrochemical applications, in photonic crystals applications, and the like.

### Fabrication

In some embodiments, methods to fabricate nanoparticle monolayers and tailored multilayers can include click chemistry as a tool. Click chemistry can have several advantages such as mild reaction conditions (e.g. room temperature, mild solvents, and neutral pH), high yield, less or no by-product, etc. In some embodiments, reactions that take place during fabrication, including some click chemistry reactions, can use Copper (I)-catalyzed azide alkyne cycloaddition (CuAAC) for the directed assembly of nanoparticles and other constituents.

Click chemistry reactions, such as those suitable for fabrication of devices disclosed herein, can include cycloaddition reactions, e.g., ruthenium-catalyzed azide-alkyne cycloaddition, and Huisgen Azide-Alkyne 1,3-Dipolar cycloaddition, copper-catalyzed Azide-Alkyne cycloaddition as well as others. One of the click chemistry reactions that can be used for the directed assembly of nanoparticles includes copper (I)-catalyzed azide alkyne cycloaddition (CuAAC), such as for the directed assembly of nanoparticles and of layers.

These reactions, including for example CuAAC, can be used for directed assembly of monolayer of azide/alkyne modified nanoparticles (e.g. gold, silica, gold-coated silica nanoparticles etc.) on alkyne/azide modified different substrates (e.g. silicon, Indium tin oxide (ITO), titanium and stainless steel). In some embodiments, tailored multilayers of silica nanoparticles can be fabricated on silicon substrate by alternative deposition of azide/alkyne modified silica nanoparticles. In some embodiments, gold nanoparticles monolayer prepared using methods disclosed herein can have excellent electrocatalytic activity, such as for water splitting and methanol oxidation and oxidation of other alcohols and other organic chemicals. In some embodiments, silica microparticle monolayers can be used in biological fields and can utilize Avidin-Biotin bioconjugation.

In some embodiments, directed assembly of monolayers of azide/alkyne modified nanoparticles from solutions can include about 1-5% (wt.) of nanoparticles (e.g. gold, silica, gold-coated silica nanoparticles etc.), or about 0.5-1% (wt.) or about 1-2% (wt.) or about 2-3% (wt.) or about 3-4% (wt.) or about 4-5% (wt.) of nanoparticles on alkyne/azide modified silicon substrate or other suitable substrate. In various embodiments, suitable substrates can include materials such as titanium, indium tin oxide, and stainless steel, and other types of nanoparticles can be utilized, such as iron oxide and gold/cadmium selenide core shell.

In some embodiments, tailored multilayers of silica nanoparticles can be fabricated on a silicon or other suitable substrate by alternative deposition of azide/alkyne modified silica nanoparticles. In some embodiments, an alternating buildup of components can be used to form a multilayer, but other build-up patterns can also be utilized such as where three, four, five, or more different components are used, and where various patterns of repeating a component with or without being interspersed by other components can be used.

In various embodiments, the methods and compositions disclosed herein and their variations can be used in different applications such as in photocatalytic water splitting, biosensing, photonic crystals, electrochemistry, electronic chips etc. Examples of uses for the technology disclosed herein also includes gold nanoparticle monolayers prepared, such as those prepared by methods disclosed herein, having electrocatalytic activity, gold nanoparticle monolayers for methanol oxidation and nanoparticle monolayers used in conjunction with Avidin-Biotin bioconjugation for biosensing applications.

### EXAMPLES

### Example 1

### Directed Assembly of Monolayers/Layers of Nanoparticles (e.g. Gold, Silica, Gold—Coated Silica Nanoparticles etc.)

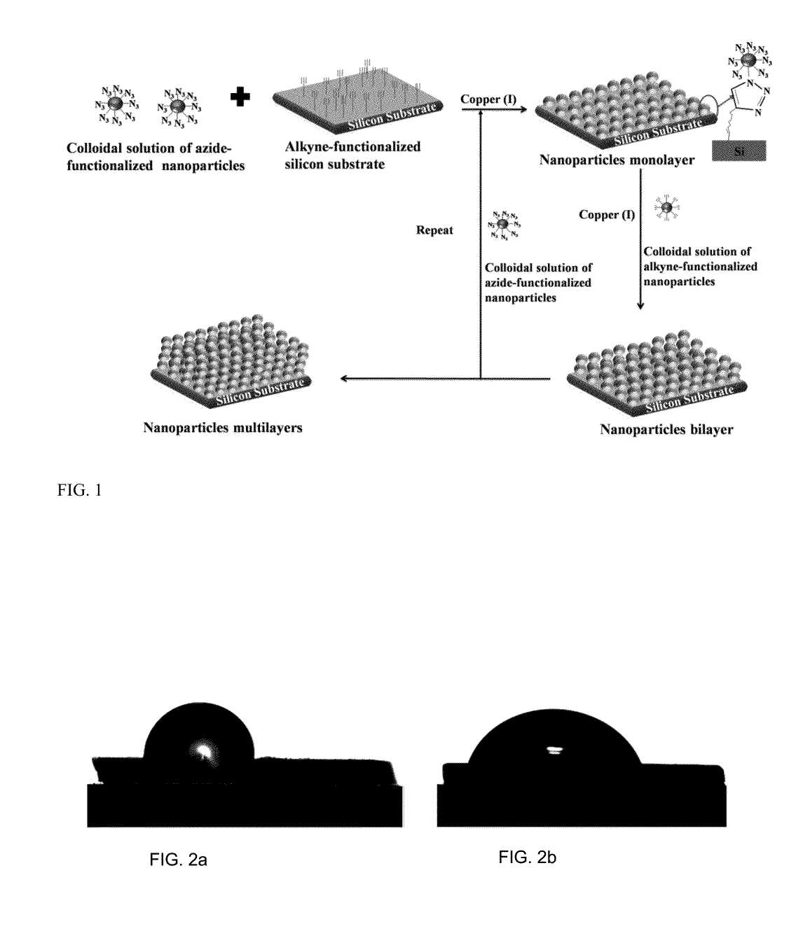

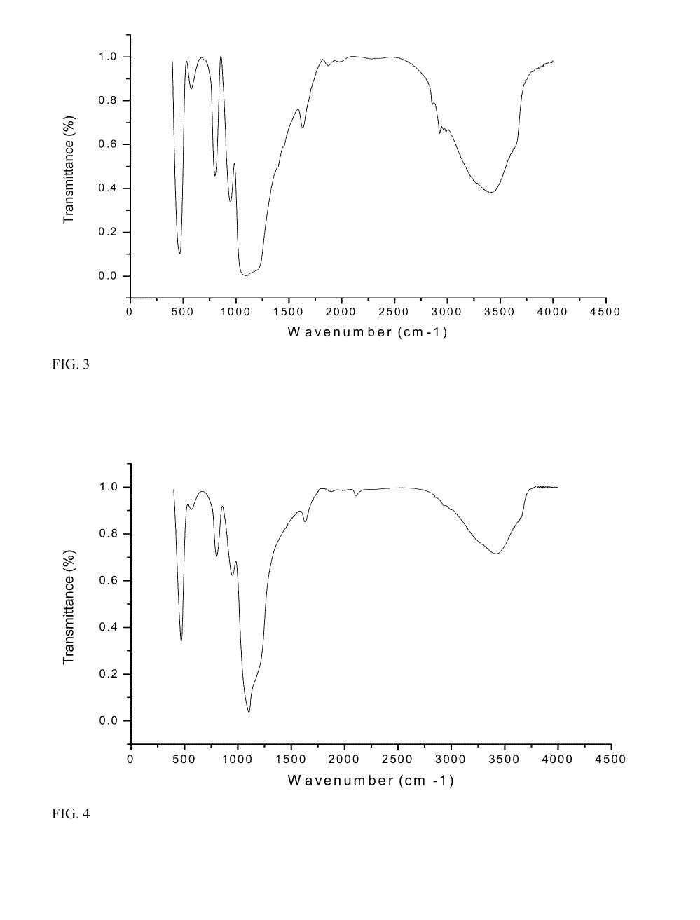

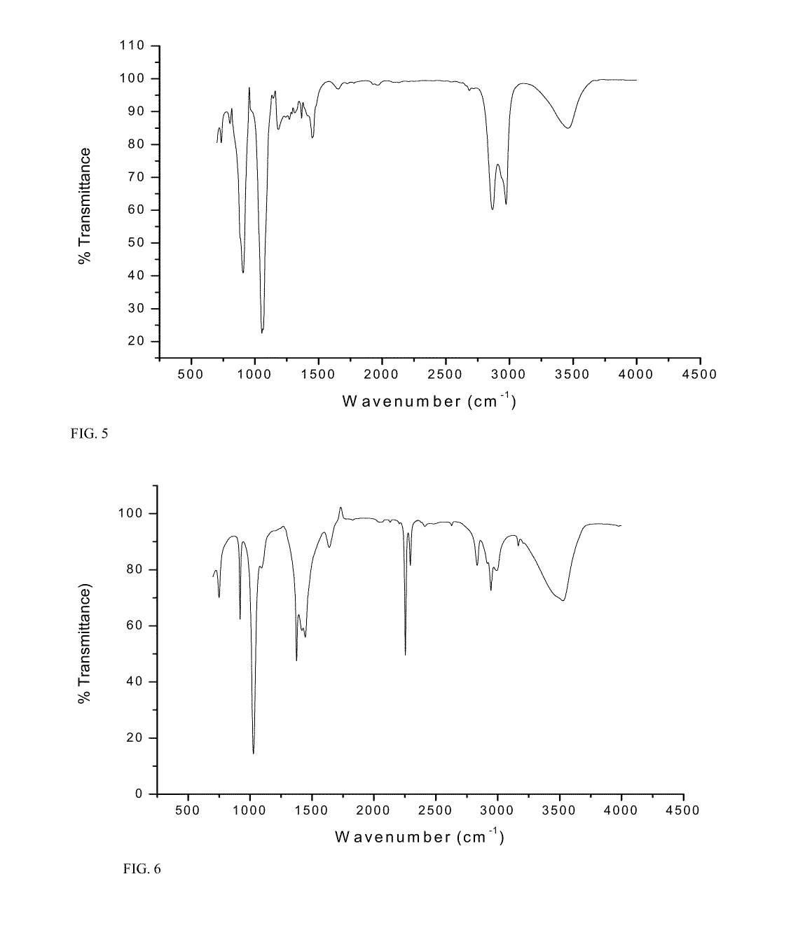

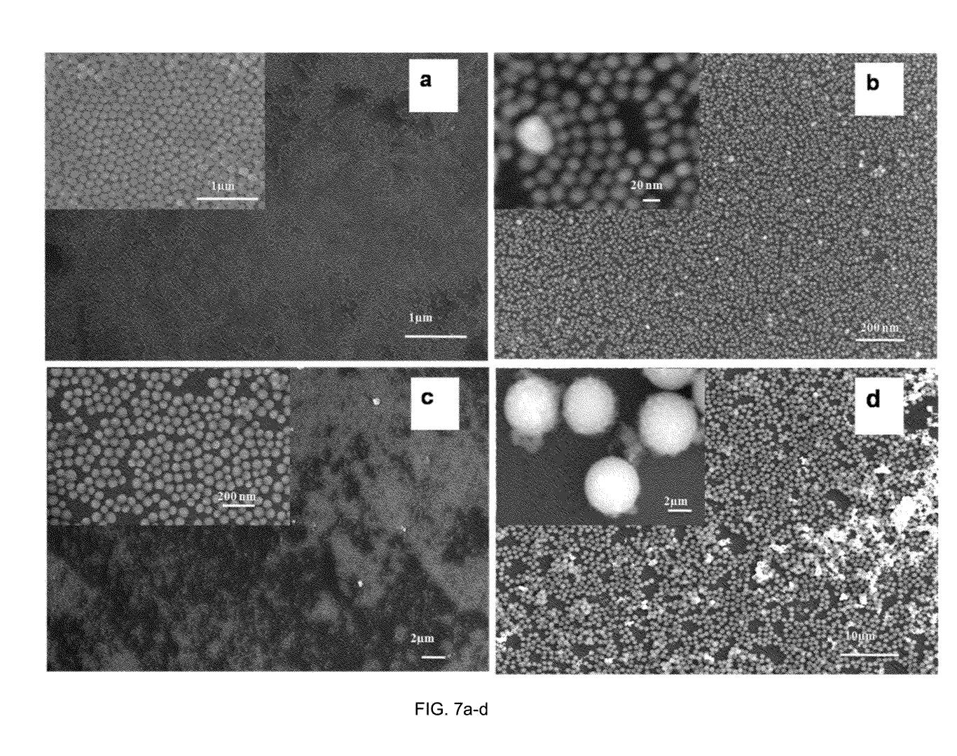

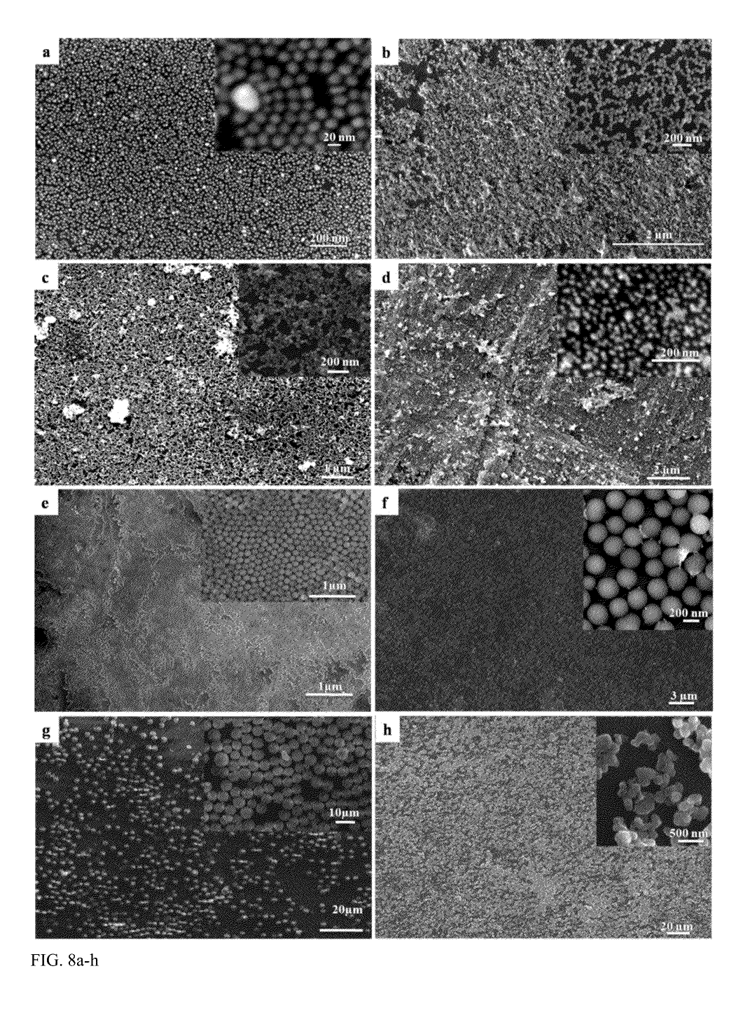

FIG. 1 shows a schematic representation of a formation of monolayer and multilayers of nanoparticles on substrate (e.g. silicon) using click chemistry. Alkyne functionalized silicon substrates were immersed in the 3.5 wt. % solution of azide functionalized nanoparticles in tetrahydrofuran (THF) and allowed the nanoparticles to settle down on silicon substrate. Alkyne functionalized silicon substrate were then removed after 12 hrs and placed in an aqueous solution of 10 mM solution of copper sulphate (CuSO₄.5H₂O) and 50 mM solution ascorbic acids for another 12 hrs to catalyze the click reaction between alkyne and azide moieties present on the surface of silicon substrate and nanoparticles respectively. Silicon substrates covered with the monolayer of azide functionalized nanoparticles were removed after 12 hrs and followed by washing with acetone and sonicated for 30 minutes in THF to remove any physically attached particles. Once the monolayer of azide functionalized nanoparticles were formed on alkyne functionalized silicon substrate, there were free azide moieties present onto nanoparticles surface which was further used to prepare the tailored multilayers of nanoparticles. Water contact angle measurement of acetylene-terminated silicon wafer shows the contact angle around 97.8±2° (FIG. 2a) which confirms the presence of hydrophobic monolayer of 1,8-nonadiyne on silicon substrate. Water contact angle measurement of silicon substrate after piranha washing but before functionalization was around 71.5±2° (FIG. 2b.) FTIR of silica nanoparticles shows the absorption peak at ˜2250 cm⁻¹ confirms the presence of alkyne group of 3-butyn-1-ol (FIG. 3) and absorption peak at around ˜2110 cm⁻¹ confirms the presence of azide moiety on silica nanoparticles (FIG. 4). FTIR of gold nanoparticles shows the absorption peak at ˜2150 cm⁻¹ confirms the presence of azide group (FIG. 5) and absorption peak at ˜2250 cm⁻¹ confirms the presence of alkyne group on gold nanoparticles surfaces (FIG. 6).

### Experimental Design for Directed Assembly of Monolayers/Layers of Different Nanoparticles: Azide Functionalization of Gold Nanoparticles

Gold nanoparticles were prepared by the citrate method in which a deep red color of solution confirms the formation of approx. 20 nm gold nanoparticles after adding 1% sodium citrate solution to heated 1 mM aq. solution of chlorauric acid (HAuCl₄) salt under continuous stirring. Gold nanoparticles were then collected by centrifugation at 10000 rpm for 50 mins. Ligand exchange with 3-chloro-1-propanethiol was performed by dispersing the gold nanoparticles in dichloromethane (DCM) and stirring the solution at room temperature for 60 hrs. The resulting nanoparticles were collected by either solvent evaporation or by centrifugation. The particles were then washed with ethanol to remove the unreacted thiol. The particles were dispersed in DCM and an equal volume of sodium azide (0.25M) in DMSO was added to the particle dispersion and stirred for 48 hrs, after which the particles were recovered by centrifugation followed by washing with water to remove unreacted sodium azide.

### Alkyne Functionalization of Gold Nanoparticles

Alkyne functionalization of gold nanoparticles was accomplished by a ligand exchange method. One ml of a solution of 1 mM 6-mercaptohexanoic acid (MHA) in ethanol was added to 25 ml of citrate stabilized colloidal gold nanoparticles (1 mM), and stirred for 60 hrs at room temperature to perform the ligand exchange. Carboxyl functionalized gold nanoparticles were recovered by centrifugation at 11,000 rpm for 50 mins and followed by washing with ethanol (twice). The functionalized gold nanoparticles were dispersed in a mixture of acetonitrile and methanol (3:1) followed by addition of 1-amino-3-butyne along with 1-ethyl-3-(3-dimethylaminopropyl) carbodiimide hydrochloride (EDC.HCl) (acts as coupling agent) and stirred further for 6 hrs. Nanoparticles were recovered by centrifugation at 11,000 rpm for 50 mins followed by washing with ethanol and water.

### Azide Functionalization of Silica Nanoparticles

Silica nanoparticles were prepared by Stober's methods. In a round bottom flask, a solution containing 50 ml of ethanol, 3 ml of ammonia and 2 ml of water was stirred for 5 mins. Then 4 ml of TEOS were added to this solution and stirred for 2 additional hours. The prepared silica nanoparticles were recovered by centrifugation at 6000 rpm for 10 mins, followed by washing with ethanol (thrice) and water (twice) to remove any unreacted ammonia and TEOS. The prepared silica nanoparticles were dried in oven at 80° C. for 12-16 hrs. In three neck flask, 1 g of prepared silica nanoparticles were added to 10 ml of toluene and sonicated for 30 mins under an inert atmosphere. A solution of 0.7 ml 3-bromopropyltrichlorosilane in 1.3 ml of toluene was added to the above sonicated solution and stirred for an additional 18 hrs at 80° C. under an inert atmosphere.

The bromo-functionalized silica nanoparticles were recovered by centrifugation followed by washing with toluene (thrice) to remove any unreacted 3-bromopropyltrichlorosilane. The bromo-functionalized silica nanoparticles were dried at 80° C. overnight in an oven. To replace the bromine group present on the silica nanoparticles with an azide group of sodium azide, 0.8 g of dried bromo-functionalized silica nanoparticles and 0.32 g of sodium azide were added to 16 ml of DMSO under an inert atmosphere and the mixture was stirred for 18 hrs at 80° C. The particles were then recovered by centrifugation and washed with ethanol (thrice) and water (twice). Finally, the azide functionalized silica nanoparticles were dried at 80° C. overnight in oven.

### Alkyne Functionalization of Silica Nanoparticles

Alkyne functionalized silica nanoparticles were prepared by co-condensation of TESO and 3-butyn-1-ol in ethanol in the presence of ammonia as catalyst. In three neck flask, 500 mg of prepared silica nanoparticles were added in toluene under inert atmosphere and sonicated it for 30 mins. 3-butyn-1-ol (300 μl) was added to above solution and stirred the solution for 24 hrs at room temperature under inert atmosphere. Functionalized silica nanoparticles were recovered by centrifugation followed by washing with ethanol (twice) and water (twice). The alkyne functionalized was dried at 80° C. overnight in oven.

### Alkyne Functionalization of Biotin

A mixture of biotin (200 mg, 0.82 mmol), propargylamine (54 mg, 0.98 mmol), and 1-ethyl-3-(3-dimethylaminopropyl)carbodiimide hydrochloride (EDC.HCl) (205 mg, 1.1 mmol) in 8 mL solution of CH₃CN/MeOH (3/1) was kept on stirring at room temperature for 6.5 hrs. Solution was concentrated under reduced pressure and redispressed the residue in methanol.

### Alkyne Functionalization of Silicon Wafer

Silicon wafer (boron doped; thickness: 380+20 micrometer, diameter: 3 inch, resistivity: 1-10 Ohm cm, Orientation: <100>+0.5 degree; Single Side Polished and P-type) (100) were cut into approximately 5×5 mm² sizes and washed with the piranha solution (H₂SO₄:H₂O₂:3:1) at 100° C. for 30 mins. After piranha washing transferred the pieces of silicon wafers into the 2.5% solution of hydrofluoric solution for 90 sec under inert atmosphere. Immediately after HF etching, silicon wafers pieces were transferred to the three neck flask containing 0.9 mM solution of 1,8-nonadiyne and kept the flask in oil bath at 170° C. for 3 hrs. Remove the silicon wafers and washed with acetone (twice), ethanol (twice) and finally with water (twice)

### Azide Functionalization of Silicon Wafer

Silicon wafer (boron doped; thickness: 380+20 micrometer, diameter: 3 inch, resistivity: 1-10 Ohm cm, Orientation: <100>+0.5 degree; Single Side Polished and P-type) (100) were cut into approximately 5×5 mm² sizes and washed with the piranha solution (H₂SO₄:H₂O₂:3:1) at 100° C. for 30 mins. Silicon wafers were immersed in the 1 mM solution of 3-bromopropyltrichlorosilane in toluene for 24 hrs room temperature. Washed the bromine functionalized silicon wafer with copious amount of toluene, acetone and ethanol. To replace the bromine group with azide immersed the bromine functionalized silicon wafer in the sodium azide solution (25 mM) in DMSO for 48 hrs at room temperature. Finally, azide functionalized silicon wafers were washed with acetone and ethanol.

### Monolayer and Multilayers of Nanoparticles on Silicon Wafer

Alkyne functionalized silicon wafers were immersed in the solution of azide functionalized nanoparticles (gold and silica) in tetrahydrofuran (THF) and allows the nanoparticles to settle down on silicon wafer for some time and an aqueous solution of 10 mM solution of copper sulphate (CuSO₄.5H₂O) and 50 mM solution ascorbic acids were added to catalyzed the click reaction between alkyne and azide moieties present on the surface of silicon wafer and nanoparticles respectively. Silicon wafers ware removed after 12 hrs followed by washing with acetone and sonication of 30 mins in order to remove any physically attached particles.

### Gold Coating of Silica Nanoparticles Using Click Chemistry

Aqueous solution of 10 mM solution of copper sulphate (CuSO₄.5H₂O) and 50 mM solution ascorbic acids were added to the mixture of alkyne functionalized gold nanoparticles (10 nm) and azide functionalized silica nanoparticles (550 nm) in DMSO in glass vial and the mixture was kept on stirring at room temperature for 12 hrs, click reaction was occurred between azide and alkyne moieties present on the surfaces of silica and gold nanoparticles respectively. Once the click reactions occurred between gold and silica nanoparticles, particles were washed with ethanol and water to remove any physically attached particles and dispersed these particles in tetrahydrofuran (THF). Follow the same procedure mentioned in above section to prepare the monolayer of alkyne functionalized gold coated azide functionalized silica nanoparticles onto azide functionalized silicon wafers.

### Example 2

### Formation of Monolayers on Silicon Substrate

FIG. 7 shows scanning electron micrographs (SEM) where the formation of a closely packed monolayer of different nanoparticles can be seen. FIG. 7a show a monolayer of azide functionalized silica deposited onto alkyne functionalized silicon substrate and FIG. 7b shows a monolayer of azide functionalized gold nanoparticles deposited onto alkyne functionalized silicon substrate using click chemistry. Inset images of FIGS. 7a & 7b show the close packing of the nanoparticles. FIGS. 7c & 7d show the formation of amonolayer of alkyne functionalized silica nanoparticles (FIG. 7c) and a monolayer of multilayered nanoparticles (alkyne functionalized gold monolayered onto azide functionalized silica nanoparticles where the size of the silica nanoparticles was ˜550 nm) (FIG. 7d) onto azide functionalized silicon substrate using click chemistry. Inset images of FIGS. 7c&d show the close packing of nanoparticles and also show that a large portion of the silicon substrate surface was covered with the nanoparticles of each monolayer.

### Example 3

### Formation of Monolayers on a Variety of Substrates

Scanning electron micrographs (SEM) in FIG. 8 show the formation of a densely-packed monolayer of gold and silica nanoparticles on a variety of substrates (silicon, glass, titania, ITO and stainless steel).

FIGS. 8a-d show monolayers of azide-functionalized gold nanoparticles on alkyne-functionalized substrates (a) silicon, (b) ITO, (c) titania and (d) stainless steel (type 304) respectively. FIGS. 8e-h show monolayers of (e) a 0.1 μm azide-functionalized silica monolayer on alkyne-functionalized silicon substrate, (g) a 5 μm azide-functionalized silica nanoparticles monolayer on alkyne-functionalized silicon substrate, (f) a monolayer of 0.33 μm azide-functionalized silica nanoparticles on alkyne-functionalized glass substrate and (h) a monolayer of alkyne-functionalized TiO₂ nanoparticles on azide-functionalized silicon substrate. The SEM images also show the nanoparticles formed closely packed monolayers over a large area without aggregation or multilayers being formed. In the case of stainless steel, the gold nanoparticles monolayer did show some aggregation which, while not wishing to be limited by theory, can be attributed to the rough surface of stainless steel after piranha washing, and can be controlled by manipulation of the surface characteristics of the stainless steel substrate to reduce roughness. The SEM images also demonstrate that methods disclosed herein can be applicable to different sizes of nanoparticles and different materials of nanoparticles and different substrate materials (e.g. gold and silica nanoparticles, 20 nm, 0.1, 0.12, 0.33 and 5 μm diameter nanoparticles as well as sizes therebetween and sizes larger and smaller). We note that silica nanoparticles formed a hexagonal close packed (hcp) monolayer on silicon substrate. Additionally, the fabrication of monolayers of alkyne-functionalized silica (size ˜120 nm) nanoparticles on azide-functionalized silicon substrate demonstrates the broad applicability of the methods disclosed herein.

### Example 4

### Multilayer Formation of Nanoparticles and Heterostructures

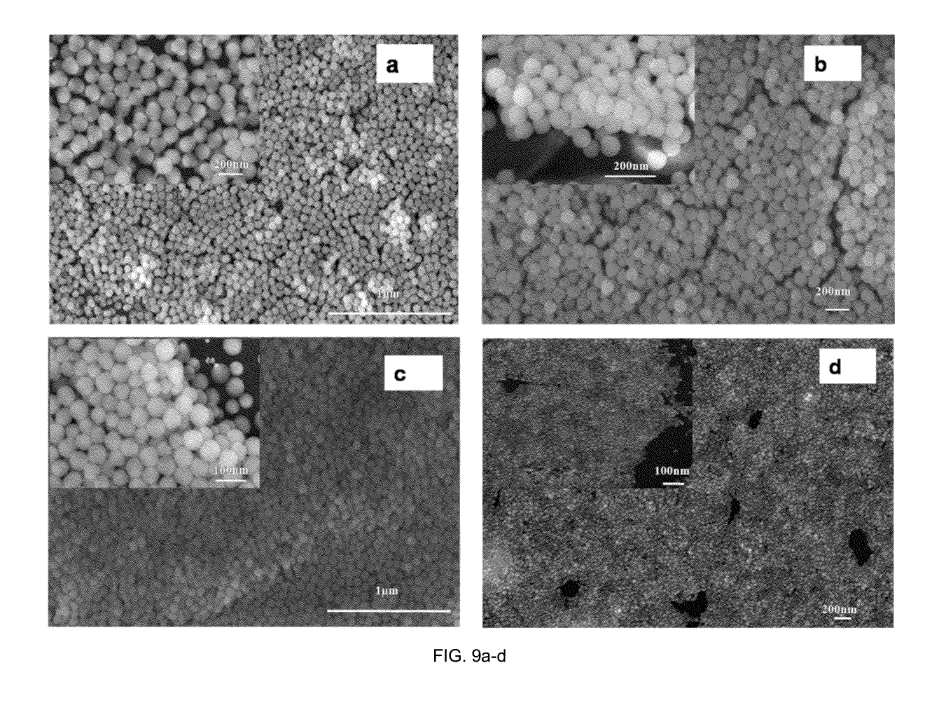

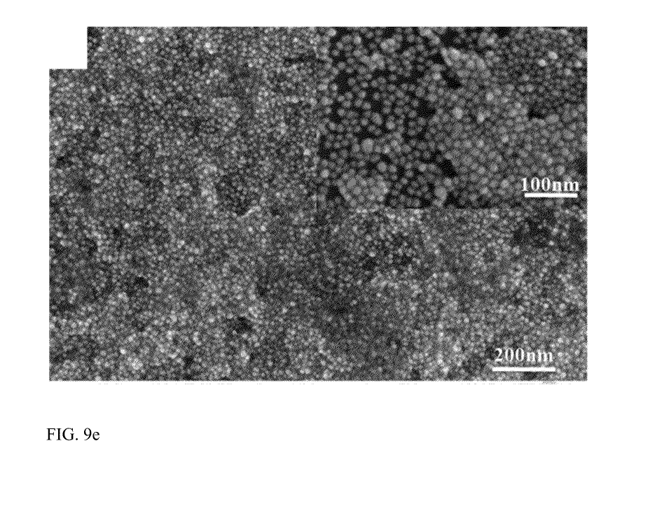

Heterostructures and nanoparticles with successive layers of various metal and semiconductor nanoparticles are shown. Such multilayered structures/particles can provides a way of fabricating hybrid structures of different band-gap semiconductor materials which can, for example, be useful in capturing a large fraction of the solar spectrum. Described are the controlled multilayer formation of silica nanoparticles, gold-TiO₂ multilayer heterostructures and gold-coated silica nanoparticle heterostructures. Tailored multilayers can be shown with silica nanoparticles as one exemplary form. FIG. 9 shows tailored multilayers of different nanoparticles fabricated by sequential deposition (LbL) of alkyne/azide-functionalized nanoparticles on freely available azide/alkyne moieties on nanoparticles monolayers.

FIG. 9a-c show SEM images of tailored multilayers of silica nanoparticles, these images show the formation of two (FIG. 9a), three (FIG. 9b), & four (FIG. 9c) layers of silica nanoparticles on alkyne functionalized silicon using a click chemistry approach with the first layer being azide functionalized silica nanoparticles, the second layer being alkyne functionalized silica nanoparticles, and continuing with alternating azide and alkyne functionalized silica nanoparticles. FIGS. 9a-c show tailored multilayers of silica nanoparticles with dense packing and regions having an hcp structure which indicates the suitability of this approach for the preparation of tailored multilayers of materials with different band-gaps, electrochemical and photoelectrochemical properties.

FIGS. 9d and 9e are SEM images showing a tailored bilayer of gold nanoparticles with the first layer being azide functionalized gold nanoparticles, and the second layer being alkyne functionalized gold nanoparticles on alkyne-functionalized silicon substrate. Additionally, FIG. 9e shows the bilayer of gold nanoparticles on alkyne-functionalized silicon substrate with minimal aggregation which further supports the generality and versatility of the proposed approach.

FIGS. 9a-e show the large area coverage by the layers of nanoparticles and good periodicity of the nanoparticles which can be desirable for photonic crystal applications

### Example 5

### Multilayer Formation of Nanoparticles and Heterostructures

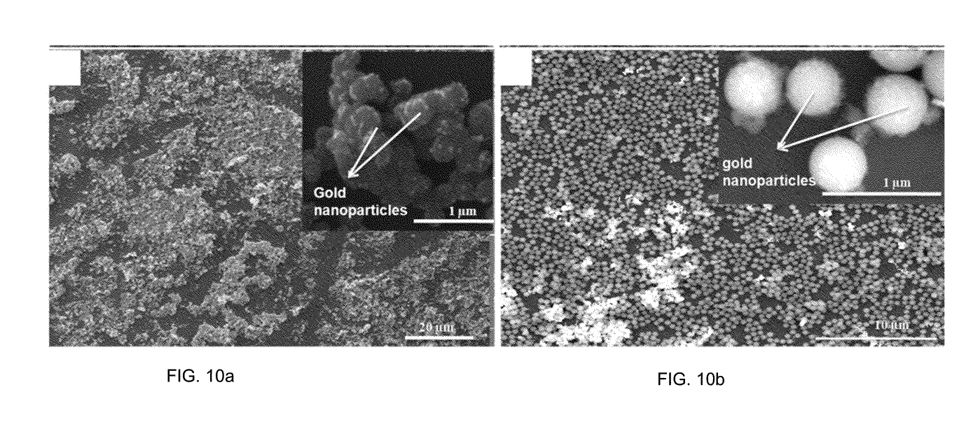

FIGS. 10a and 10b are SEMs of azide-functionalized gold bilayer on alkyne-functionalized TiO₂ monolayer (FIG. 10a) and azide-functionalized gold-coated silica nanoparticles (size ˜550 nm, FIG. 10b) monolayers on azide functionalized silicon substrate fabricated by methods as described above in Example 1. FIGS. 10a and 10b show that the methods disclosed herein have the ability to assemble a variety of nanoparticles to produce controlled hybrid multilayer heterostructures.

### Examples 6-10

In Examples 6-10, below, electrochemical and photocatalytic applications of monolayers of gold nanoparticles are shown.

The tailored monolayers and multilayers disclosed herein can be applied over large substrate areas and have potential applications in various fields such as water splitting and methanol oxidation by electrochemical or photoelectrochemical cells, photonic crystals, biosensors, etc. In examples 6-10, the application of gold nanoparticles monolayer on different substrate (e.g. silicon, ITO, stainless steel and titanium) for water splitting, methanol oxidation and photocatalytic degradation of Rhodamine B dye is shown. These examples show that the gold nanoparticle monolayers at different substrates have excellent catalytic activity and stability. Without wishing to be limited by theory, it is believed that enhanced catalytic activity and/or stability is due at least in part to plasmonic enhancement of local electromagnetic fields induced by the gold nanoparticles.

### Example 6

### Methanol Oxidation Using Gold Nanoparticle Monolayer

A layered structure of gold nanoparticles deposited on a silicon substrate was used for oxidation of methanol. The layered structure was made by methods described in Example 1, using azide functionalized gold nanoparticles and alkyne functionalized silicon. The layered structure was used to oxidize solutions of 0.1 M or 2.5 M methanol containing 0.1 M, 0.5 M or 1 M NaOH. The potential range has been restricted in all four cases (i.e., Au@silicon substrate, Au@titania substrate, Au@ITO substrate, and Au@stainless steel (type 304) substrates) to 1.2 V (all potentials are measured vs Ag/AgCl and are expressed vs SCE) to prevent the electrochemical oxidation of gold that occurs at potentials beyond 1.3 V.

FIG. 11 shows the voltammetric profile for the gold nanoparticles stabilized on silicon substrate in 0.1 M NaOH+2.5 M methanol at various scan rates. For a scan rate 10 mV/s, the highest current density observed is 0.86 mAcm⁻² which occurs at 1.2 V. The potential range for the experiment was restricted so as to prevent the electrochemical oxidation of gold which can occur at potentials beyond 1.3 V. As can be seen in FIG. 11, the catalyst retains high activity for methanol oxidation even during the negative portion of the scan, where the potential is decreasing. Without wishing to be limited by theory, it is believed that the high current density in the negative portion of the scan can be attributed to a high concentration of methanol in the vicinity of the electrode which prevents the mass transfer diffusion limitations from affecting the current during the experiment.

Cyclic voltammetric measurements were also carried out at high scan rates of 1 V/s and 2 V/s (FIG. 11) which show a decrease in the observed current during the negative scan. Without wishing to be limited by theory, it is believed that at higher scan rates, only the active sites that are easily accessible contribute to the current and the one that are hindered do not receive methanol.

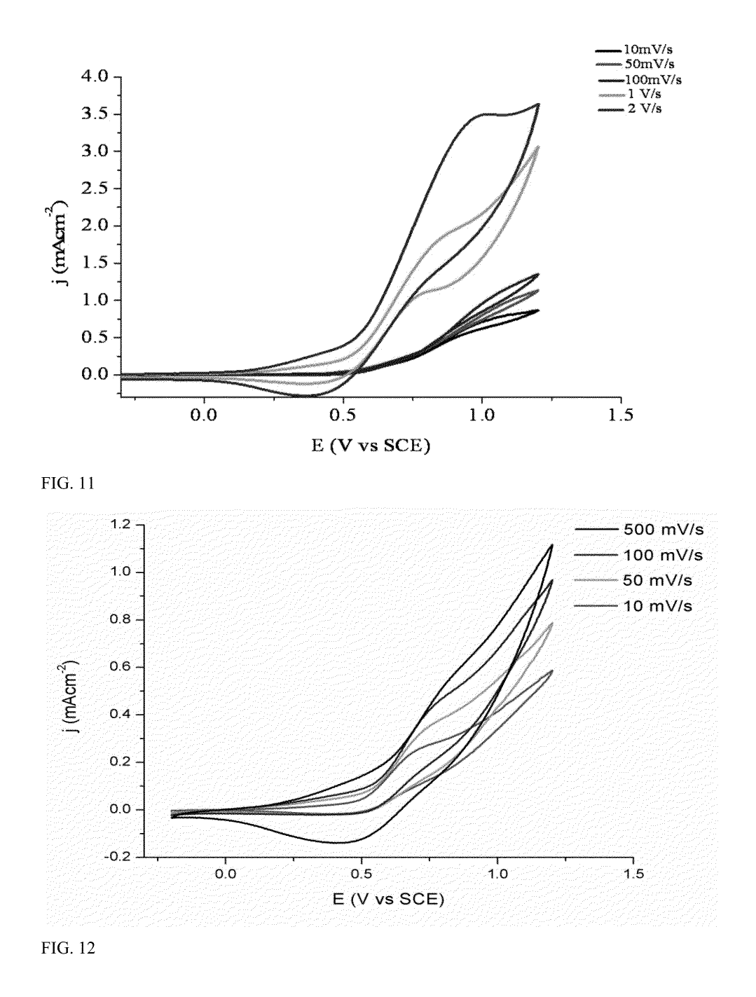

During scans at potentials above 0.5 V, bubble formation was observed. Without wishing to be limited by theory, it is believed that this gas is CO₂, which immediately escapes from the system, and the absence of CO₂ results in the absence of a reduced peak during the negative portion of the scan in FIG. 11. The cyclic voltammetry (CV) measurements carried out at low concentration of methanol (FIG. 12) show a significant decrease in the current density on negative scan even at low scan rates. While not wishing to be limited by theory, this decrease in current density is believed to be because of mass transfer diffusion limitation.

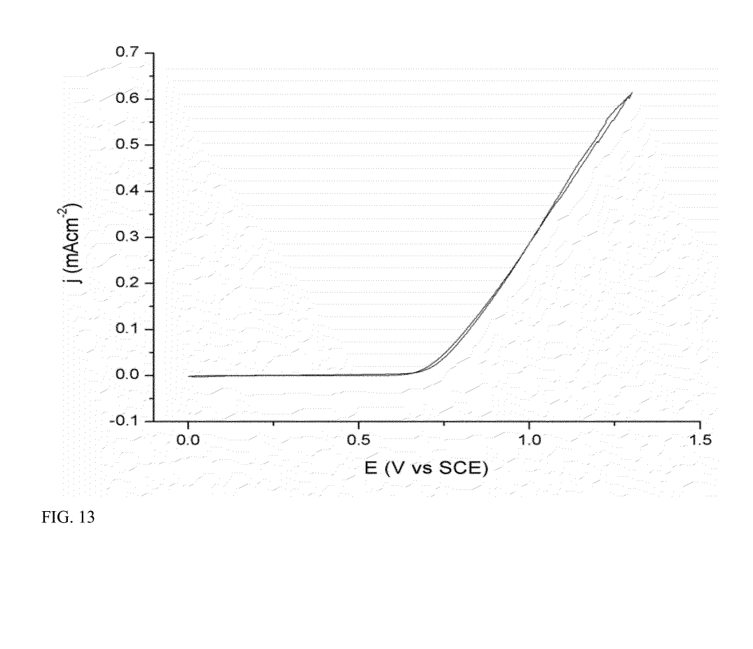

FIG. 11 and FIG. 12 show two distinct regions in the voltammetric profiles. The onset of methanol oxidation starts at about 0.5 V and the current increases gradually until about 0.7 V after which the rate of increase in current is lower. The current increases at this lower rate until about 0.9 V and then increases sharply at higher potentials. Without wishing to be limited by theory, it is believed that the voltammetric scan with only 0.1 M NaOH in the electrolyte and no methanol (FIG. 13) shows chemisorptions of OH⁻ ions, which begins at about 0.7 V and the change in nature of the methanol oxidation curve beyond 0.7 V can be attributed to this chemisorption.

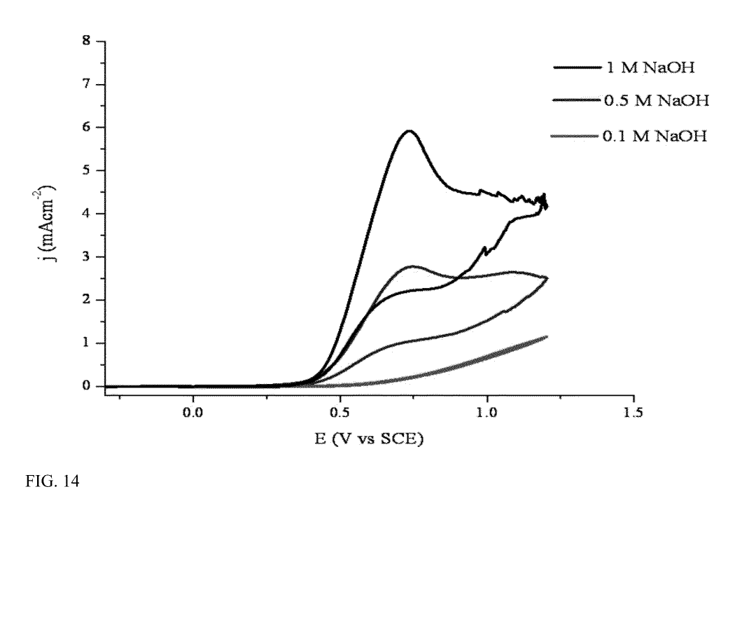

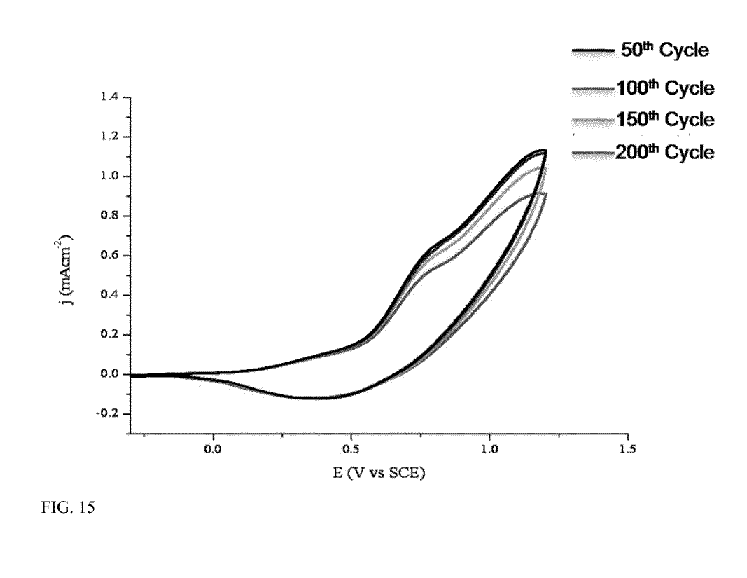

As OH⁻ plays a major role in methanol oxidation at all potentials, it is interesting to observe the response of the system on varying the NaOH concentration. Consequently, voltammetric studies were carried out in 0.1 M NaOH and 2.5 M MeOH, 0.5 M NaOH and 2.5 M MeOH and 1 M NaOH and 2.5 M MeOH with the Au/Si layered substrate described above. FIG. 14 shows the voltammetric profile at 50 mV/s scan rate. At 0.1 M NaOH it is observed that the onset of methanol oxidation occurs at about 0.6V while at 0.5 M and 1 M NaOH onset potential is observed to be about 0.4 V. Without wishing to be limited by theory, it is believed that this change in onset potential indicates that abundant activated OH⁻ is available on the surface of AuNPs even before OH⁻ is chemisorbed on the AuNPs, and that these activated OH⁻ are weakly adsorbed hydroxyl ions that play a crucial role in the methanol oxidation at potentials where chemisorption of OH⁻ does not occur. Further, from the onset potential, the oxidation current rises steeply until about 0.7 V, beyond which the methanol and the OH⁻ anions start competing for the active sites. As a result of this the current decreases until about 0.85 V at which the coverage of active sites with OH⁻ reaches a maximum. Once this maximum is attained the current stabilizes and the reaction proceeds via formation of methoxy radicals that react with OH— adsorbed to form formaldehyde and formic acid, as shown in equations 1 and 2.

CH₃OH +OH⁻→CH₃O⁻+H₂O (1)

CH₃O⁻+OH_{ads}⁻→HCHO+H₂O (2)

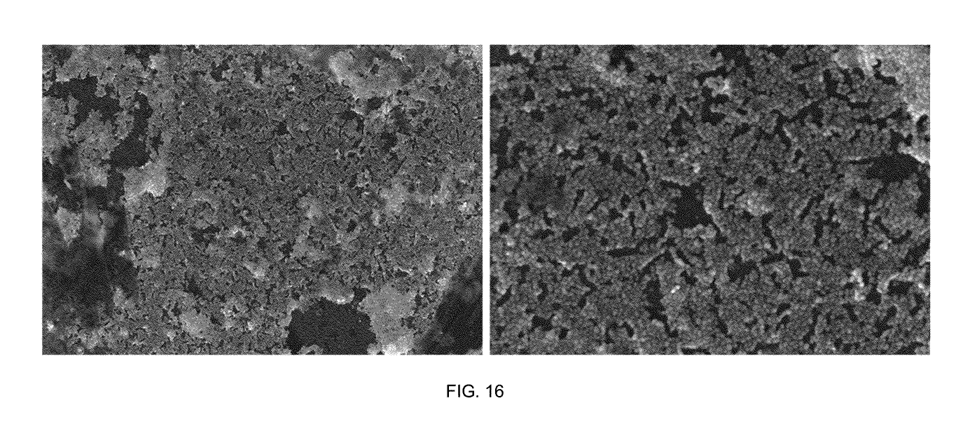

Stability of the AuNPs stabilized on silicon substrate, the cyclic voltammetric study was carried out for 150 cycles. FIG. 15 displays the activity of the layered nanoparticle structure after the 50^{th}, 100^{th}, 150^{th} and 200^{th} cycles for Au/Si substrate in 0.1 M NaOH and 0.1 M methanol at 50 mV/s scan rate. The activity of the catalyst gradually decreased from about 1.1 mAcm⁻² in the 50^{th} cycle to about 0.9 mAcm⁻² in the 200^{th} cycle. Without wishing to be limited by theory, it is believed that his decrease in activity is associated with gold oxidation following the formation of pre-oxidation species. The peak observed at about 0.4 V during the negative portion of the scan is believed to be attributed to the reduction of gold nanoparticles which only partially reduces the oxidized gold and therefore leads to a net reduction in the activity of AuNPs. FIG. 16 shows SEM images of the gold nanoparticles after 250 cycles were carried out and shows good stability of the nanoparticle monolayer.

### Example 7

### Electrochemical Methanol Oxidation with Multiple Nanoparticle Layer-Substrate Combinations

Layered structures of gold nanoparticles deposited on a silicon substrate were used for oxidation of methanol. The layered structure was made by methods described in Example 1, using azide functionalized gold nanoparticles and alkyne functionalized silicon substrate (Au@silicon), titanium (Au@Ti), indium tin oxide (Au@ITO), and on stainless steel (type 304) (Au@SS) and used as a working electrode. The layered structure was used to oxidize solutions of 0.1 M or 2.5 M methanol containing 0.1 M, 0.5 M or 1 M NaOH as in Example 6.

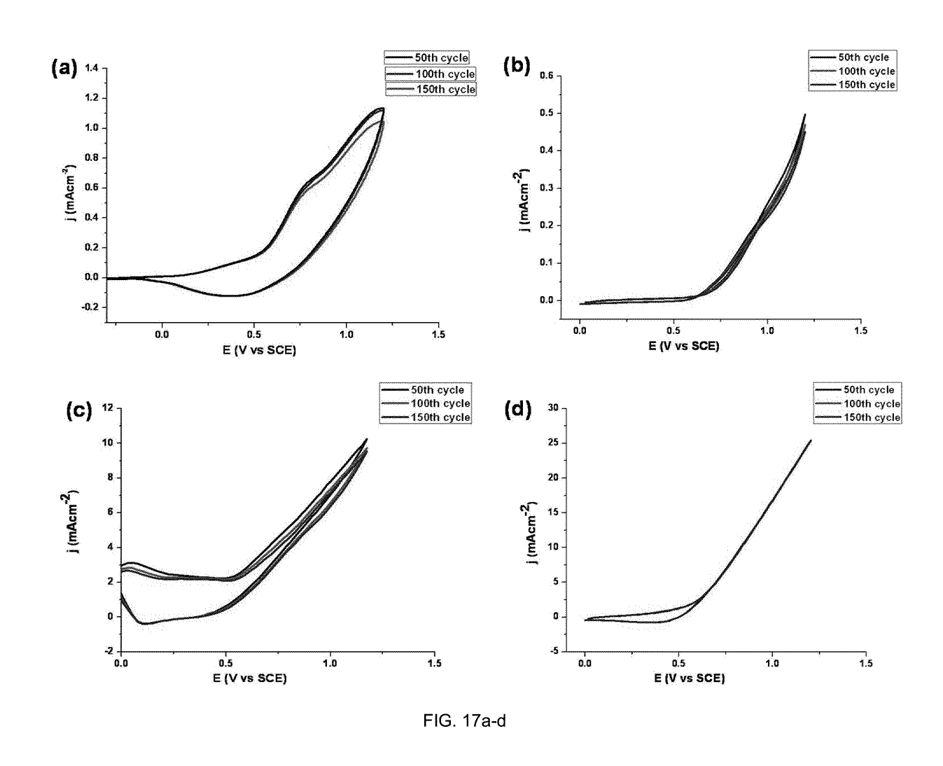

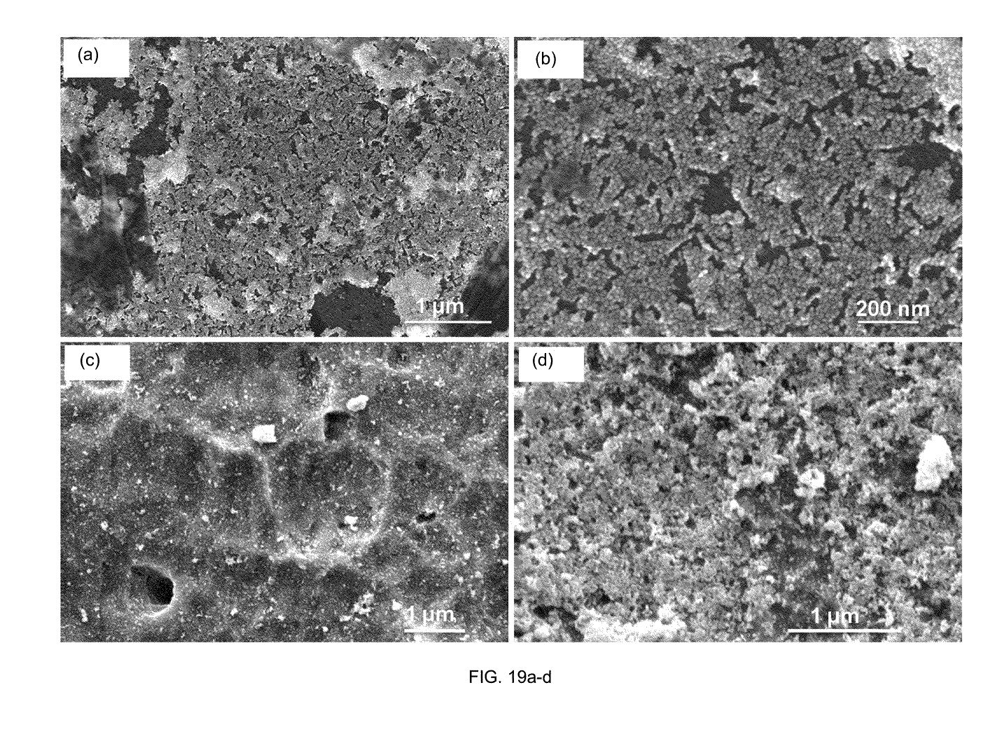

FIG. 17 shows the cyclic voltammetric profile for the gold nanoparticles monolayers on silicon (FIG. 17a), titanium (FIG. 17b) and ITO (FIG. 17c) substrates and an unlayered stainless steel substrate (FIG. 17d) in 0.1 M NaOH+2.5M MeOH at 500 mV/s up to 150 cycles in a stability analysis. FIG. 17 shows that the current density and cataltyic activity observed for oxidation of methanol is very high with gold nanoparticles monolayers compared to bare substrates and, while not wishing to be limited by theory, it is believed that this high catalytic activity of gold nanoparticles monolayers is due to plasmonic enhancement of local electromagnetic fields induced by the gold nanoparticles which increases the rate of electron-holes generation at the interface of semiconductor substrates and gold nanoparticles. Further, these electron-hole charge carriers generated near the interfaces reach active sites more readily as compared to electron-hole charge carriers generated in the bulk, and the electron-hole charge carriers generated near the interface have a lower recombination rate which leads to the improved catalytic activity for the nanoparticle layered samples. The monolayers are highly stable without losing catalytic activity even after 150 cycles, as shown in FIGS. 19a-d, which are SEMs of the gold nanoparticle monolayers on silicon (FIG. 19a), ITO (FIG. 19b), titanium (FIG. 19c) and stainless steel (FIG. 19d) after the methanol oxidation analysis. The potential range for the experiment for all four cases (i.e. Au@silicon, Au@TiO₂, Au@ITO and Au@SS) was restricted to 1.2 V so as to prevent the electrochemical oxidation of gold which can occur at potentials beyond 1.3 V.

During scans at potentials above about 0.5 V, bubble formation was observed. Without wishing to be limited by theory, it is believed that this gas is CO₂ which immediately escapes from the system and results in the absence of a reduced peak during the negative portion of the scans.

The voltammetric profiles shown in FIG. 172 had three distinct regions after onset of methanol oxidation at about 0.5 V with the first region showing the current increasing gradually until about 0.7 V, the second region showing a lower rate of increase in the current up to about 0.9 V, and the third region showing the current increase sharply at still higher potentials.

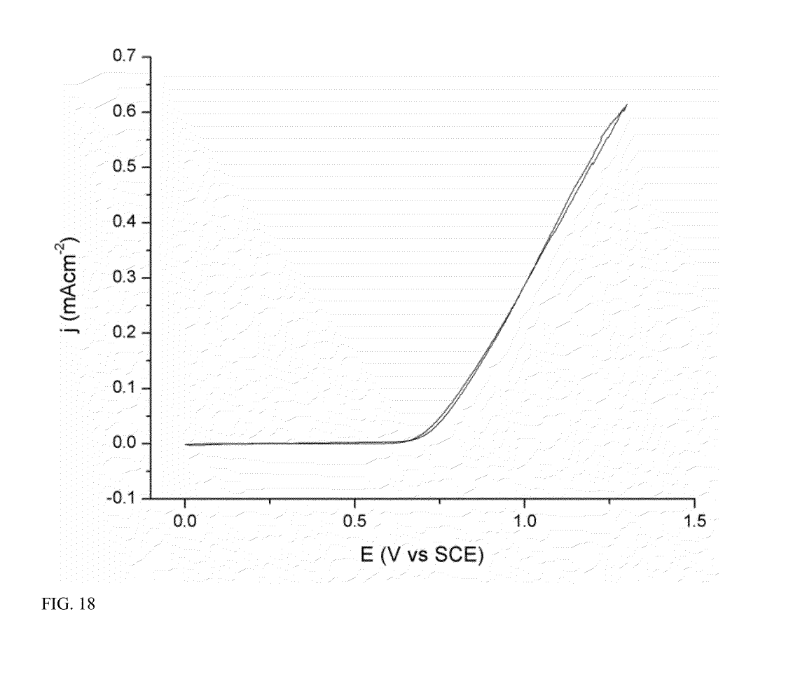

FIG. 18 shows the results of a control experiment with only NaOH in the electrolyte. Without wishing to be limited by theory, it is believed that the voltammetric scan of FIG. 18 with only 0.1 M NaOH in the electrolyte shows chemisorption of OH⁻ ions, which begins at about 0.7 V and this chemisorption changes the nature of methanol oxidation above about 0.7 V. It is also believed that the chemisorption of these oxygen species (OH⁻ ions) on gold nanoparticle surfaces can play an important role in electrochemical oxidation of methanol.

### Example 8

### Electrochemical Water Splitting

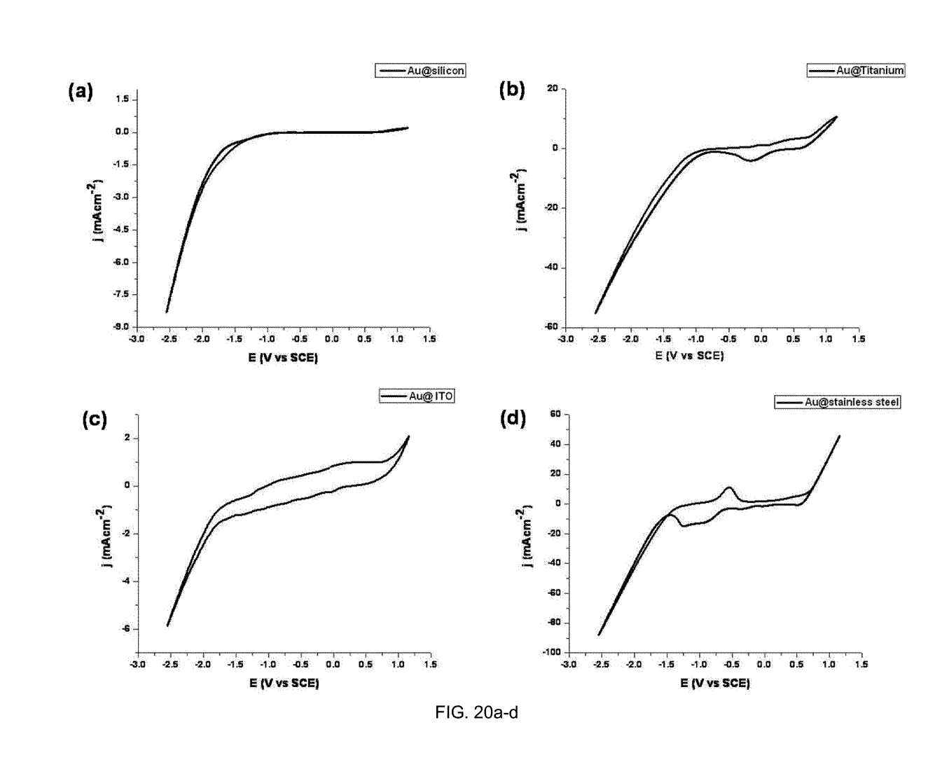

Layered structures of gold nanoparticle monolayers on different substrates were used for electrochemical water splitting. The layered structures were made by methods described in Example 1, using azide functionalized gold nanoparticles and alkyne functionalized silicon, ITO, titanium and stainless steel (type 304) substrates, and used as a working electrode. The cyclic voltammetric profiles shown in FIG. 20 were conducted in 0.1 M NaOH and at a 100 mV/s scan rate to demonstrate the utility of layered nanoparticle structures in water splitting. FIG. 20 shows the excellent electrocatalytic activity and stability of the layered nanoparticle structures.

The onset potential at around 0.7V (vs. standard calomel electrode (SCE)) for all four samples shows oxygen evolution with current densities of approximately 0.6, 11, 2.3 and 45 mA/cm² for gold nanoparticle monolayers on silicon (FIG. 20a), titanium (FIG. 20b), ITO (FIG. 20c) and stainless steel (FIG. 20d) substrate, respectively. The Au@stainless steel shows the highest current density. Without wishing to be limited by theory, it is believed that this result may be because stainless steel is a metal which along with gold generates more electron-hole charge carriers to facilitate the water splitting. The onset potential around 1.4V (vs. SCE) for Au@silicon, Au@ITO, Au@titanium and Au@stainless steel during the reverse portion of the scan shows the hydrogen evolution reaction.

As explained above in Example 7, it is believed that this increase in catalytic activity for the samples is due to plasmonic enhancement of local electromagnetic fields induced by the gold nanoparticles.

### Example 9

### Photochemical degradation of Rhodamine B

Layered structures of gold nanoparticle monolayers on different substrates were used for photochemical degradation of Rhodamine B (RhB). This work shows that layered structures, as disclosed herein, can be used to oxidize/degrade molecules including organic molecules such as Rhodamine B. The layered structures were made by methods described in Example 1, using azide functionalized gold nanoparticles and alkyne functionalized silicon and ITO substrates, and the layered structures were used as photocatalysts. Controls used in the experiments were bare silicon (no gold monolayer), bare ITO (no gold monolayer), and no substrate or layered substrate (no catalyst, irradiation only.)

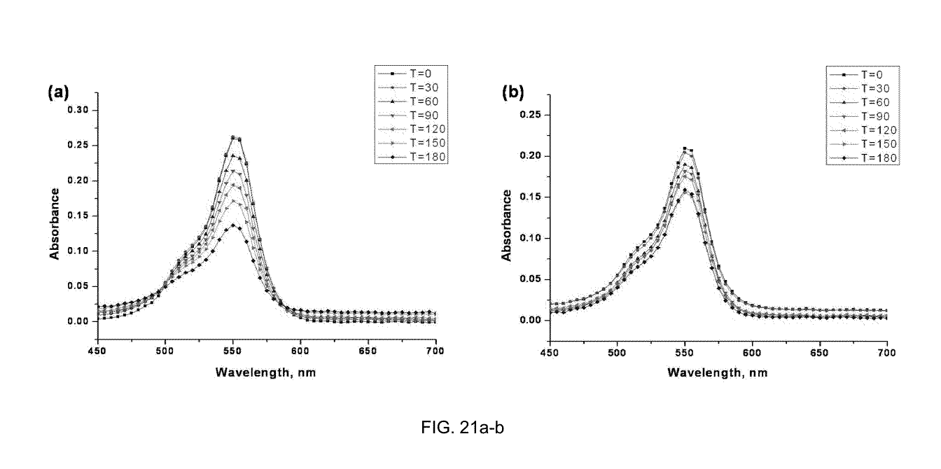

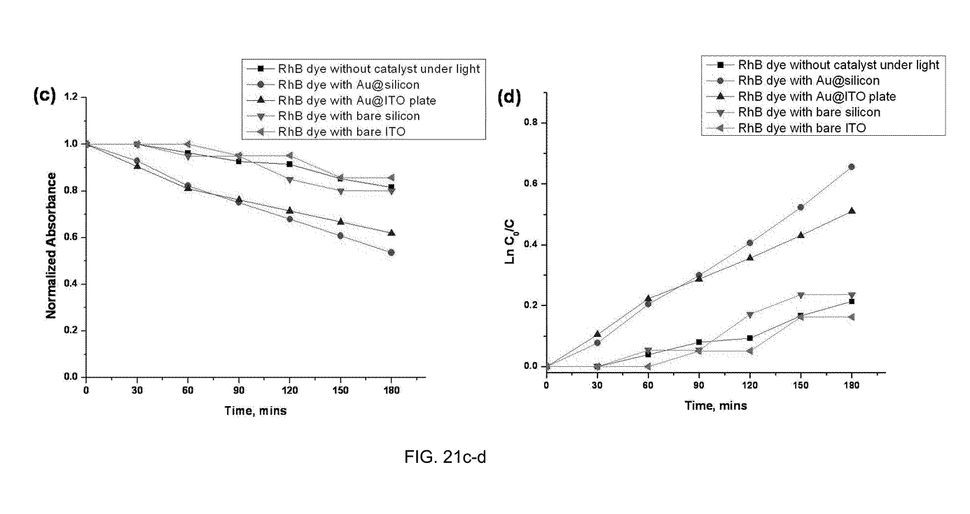

FIG. 21 shows the photochemical degradation of Rhodamine B (RhB) dye solution in neutral aqueous medium. FIGS. 21a and 21b are the UV-visible spectra of the Rhodamine B dye solutions in contact with Au@silicon (FIG. 21a) and Au@ITO (FIG. 21b) at different times in minutes. FIG. 21c shows the absorbance at 553 nm vs. time for Au@Si and Au@ITO as well as the control conditions. FIG. 21d shows the rate constant curve for RhB dye solution in contact with the different samples. The decrease in the absorbance peaks at 553 nm with time seen in FIGS. 21a-d indicates the degradation of RhB dye in the presence of Au@silicon and Au@ITO, and shows that Au@silicon and Au@ITO possess high catalytic activity compared to the control samples. The calculated pseudo-first-order rate constants in the presence of Au@silicon and Au@ITO were found to be 0.003 and 0.002 min¹, respectively, which are high compared to the control samples. FIGS. 21a-d also shows that, Au@silicon has better catalytic activity (48% degradation) compared to Au@ITO (40% degradation.) Without wishing to be limited by theory, it is believed that this greater catalytic activity of Au@silicon may be because of the single crystalline nature of silicon and also because silicon itself absorbs light which further helps in improving the catalytic efficiency along with the gold nanoparticles.

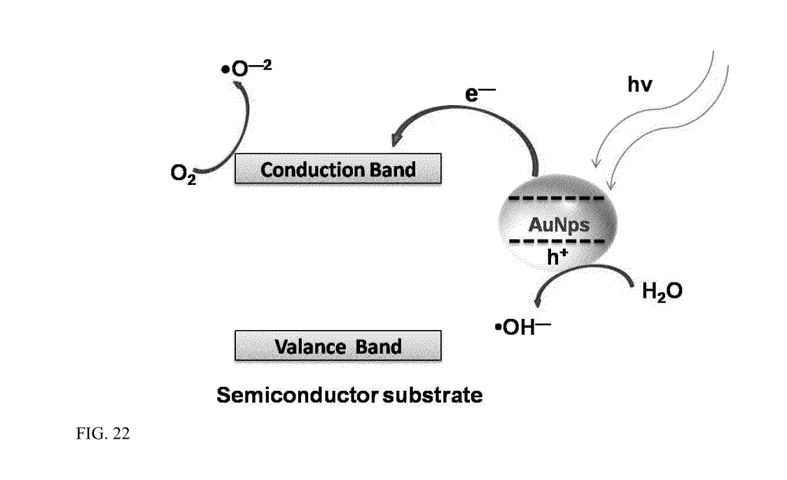

Without wishing to be limited by theory, FIG. 22 shows a schematic representation of a possible mechanism which plays a role in photocatalytic degradation of RhB dye. Upon illumination with light, the gold nanoparticles on the semiconductor surface absorb the incident UV-visible light due to its surface plasmon resonance (SPR) and generates electrons. These photogenerated electrons then migrate from the gold to the conduction band of the semiconductor where it is captured by an adsorbed O₂ molecule and generates .O⁻² species and the photogenerated holes react with water molecules to generate hydroxyl (.OH) radicals which are in turn mainly responsible for the degradation of the RhB dye.

In addition, gold nanoparticles on a semiconductor surface can improve the charge transfer at the metal-semiconductor interface which can help to avoid the recombination of charge carriers. A plot of InC₀/C vs. time shown in FIG. 21d shows that in the presence of gold nanoparticles layered on semiconductors, such as silicon and ITO, the RhB dye degradation follows a pseudo-first order reaction mechanism. The calculated pseudo-first order rate constant in the presence of Au@silicon and Au@ITO were found to be 0.003 min⁻¹ and 0.002 min⁻¹, respectively, which are higher than the control samples. Further, as can be seen in FIG. 21d, the control samples did not follow a pseudo-first order degradation mechanism. In addition, under dark conditions (no incident light), there was almost no change in the absorbance peak intensity for almost 200 mins for any of the gold nanoparticle layered structures or controls.

### Example 10

### Avidin-Biotin Bioconjugation

Layered structures of silica nanoparticle monolayers on glass substrate was used for bioconjugation of avidin and biotin. The layered structure was made by methods described in Example 1 using azide functionalized 5 μm silica particles and alkyne functionalized glass. Once the monolayer of silica microparticles was formed, the surface of the azide functionalized silica microparticles was modified with alkyne functionalized biotin using the methods of Example 1 for specific binding of fluorescein isothiocyanate-avidin.

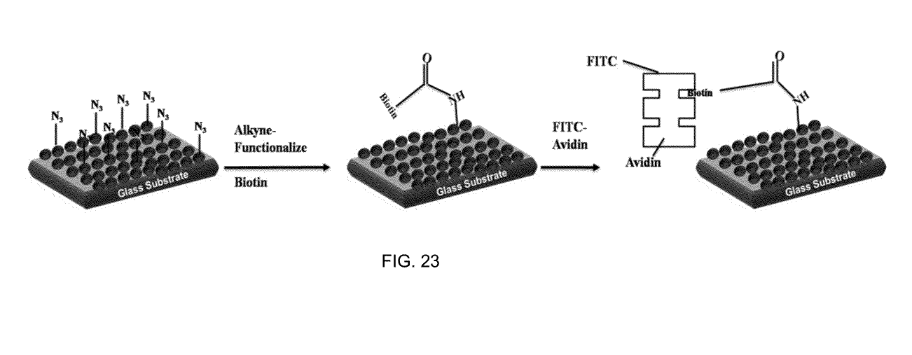

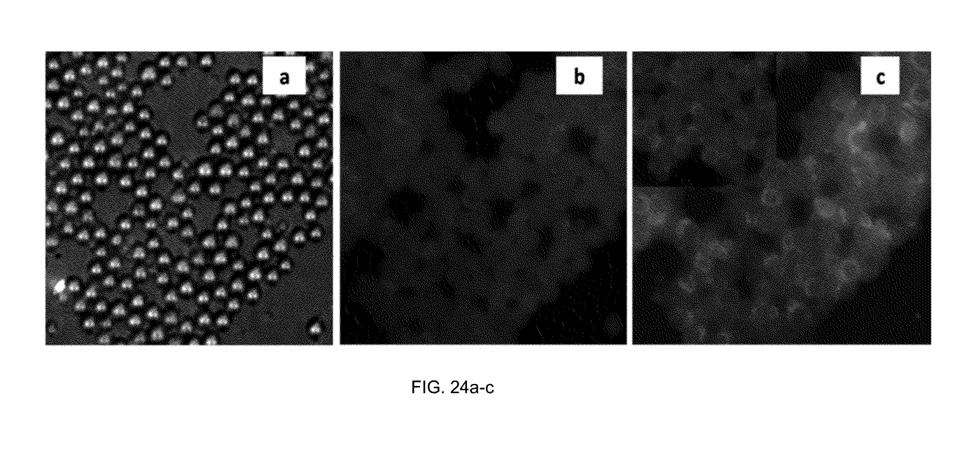

FIG. 23 is a schematic diagram showing this bioconjugation of avidin and biotin. FIG. 24 as how a bright field image of an azide functionalized 5 μm silica particles (rhodamine isothiocyanate labeled) monolayer on alkyne functionalized glass substrate. FIG. 24 b shows a fluorescence image (FIG. 24b) of an azide functionalized 5 μm silica particles (rhodamine isothiocyanate labeled) monolayer on alkyne functionalized glass substrate. FIG. 24 c is a fluorescence image of bioconjugated fluorescein isothiocyanate avidin-biotin-silica particles (5 μm) on a glass substrate, and the inset image shows the overlaid images of rhodamine isothiocyanate and fluorescein isothiocyanate.

Having now described the technology in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Concepts as written and equivalents as applicable. Reference to a concept element in the singular is not intended to mean “one and only one” unless explicitly so stated. Moreover, no element, component, nor method or process step in this disclosure is intended to be dedicated to the public regardless of whether the element, component, or step is explicitly recited in the Concepts. No concept element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “comprising the step(s) of . . . .”

### Concepts

At least the following Concepts are presented herein.

Concept 1. A method for generating layered structures, the method comprising:

reacting an azide-functionalized material with an alkyne-functionalized substrate to form a layer on the substrate, wherein the reaction couples the azide-functionalized material to the alkyne group of the alkyne-functionalized substrate.

Concept 2. The method of concept 1, wherein the substrate is a silicon substrate.

Concept 3. The method of any of concepts 1-2, wherein the azide-functionalized material is an azide-functionalized nanoparticle or microparticle.

Concept 4. The method of any of concepts 1-3, wherein the azide-functionalized material comprises gold.

Concept 5. The method of any of concepts 1-4, wherein the reaction utilizes a catalyst.

Concept 6. The method of any of concepts 1-5, wherein the reaction utilizes copper (I) as a catalyst.

Concept 7. The method of any of any of concepts 1-6, further comprising:

reacting an alkyne-functionalized material with the azide functionalized material present on a substrate to form a second layer.

Concept 8. The method of any of concepts 1-7, further comprising three or more layers wherein each layer is formed by alternating azide-functionalized material and alkyne-functionalized material, wherein the first layer is coupled to the substrate, and each successive layer is coupled to an immediately preceding layer.

Concept 9. The layered structure made by any of the methods of concepts 1-8.

Concept 10. The use of the layered structure of concept 9 for catalysis.

Concept 11. The use of the layered structure of concept 9 for separating at least a first portion of a combination of materials from a second portion of the combination of materials.

Concept 12. A method for generating layered structures, the method comprising:

reacting an alkyne-functionalized material with an azide-functionalized substrate to form a layer on the substrate, wherein the reaction couples the azide-functionalized material to the alkyne group of the alkyne-functionalized substrate.

Concept 13. The method of concept 12, wherein the substrate is a silicon substrate.

Concept 14. The method of any of concepts 12-13, wherein the alkyne-functionalized material is an alkyne-functionalized nanoparticle or microparticle.

Concept 15. The method of any of concepts 12-14, wherein the alkyne-functionalized material comprises gold.

Concept 16. The method of any of concepts 12-15, wherein the reaction utilizes a catalyst.

Concept 17. The method of any of concepts 12-16, wherein the reaction utilizes copper (I) as a catalyst.

Concept 18. The method of any of concepts 12-17, further comprising:

reacting an azide-functionalized material with the alkyne functionalized material present on a substrate to form a second layer.

Concept 19. The method of any of concepts 12-18, further comprising three or more layers wherein each layer is formed by alternating alkyne-functionalized material and azide-functionalized material, wherein the first layer is coupled to the substrate, and each successive layer is coupled to an immediately preceding layer.

Concept 20. The layered structure made by any of concepts 12-19.

Concept 21. The use of the layered structure of concept 20 for catalysis.

Concept 22. The use of the layered structure of concept 20 for separating at least a first portion of a combination of materials from a second portion of the combination of materials.

We claim:

1. A method for generating layered structures, the method comprising:
reacting an azide-functionalized material with an alkyne-functionalized substrate to form a layer on the substrate, wherein the reaction couples the azide-functionalized material to the alkyne group of the alkyne-functionalized substrate, wherein the azide-fuctionalized material is a nanoparticle or a nanoparticle.

2. The method of claim 1, wherein the substrate is a silicon substrate.

3. The method of claim 1, wherein the azide-functionalized material comprises gold.

4. The method of claim 1, wherein the reaction utilizes a catalyst.

5. The method of claim 1, wherein the reaction utilizes copper (I) as a catalyst.

6. The method of any of claim 1, further comprising:
reacting an alkyne-functionalized material with the azide functionalized material present on a substrate to form a second layer.

7. The method of claim 1, further comprising three or more layers wherein each layer is formed by alternating azide-functionalized material and alkyne-functionalized material, wherein the first layer is coupled to the substrate, and each successive layer is coupled to an immediately preceding layer.

8. The layered structure made by claim 1.

9. The use of the layered structure of claim 8 for catalysis.

10. The use of the layered structure of claim 8 for separating at least a first portion of a combination of materials from a second portion of the combination of materials.

11. A method for generating layered structures, the method comprising:
reacting an alkyne-functionalized material with an azide-functionalized substrate to form a layer on the substrate, wherein the reaction couples the azide-functionalized material to the alkyne group of the alkyne-functionalized substrate, wherein the azide-functionalized material is a nanoparticle or a microparticle.

12. The method of claim 11, wherein the substrate is a silicon substrate.

13. The method of claim 11, wherein the alkyne-functionalized material comprises gold.

14. The method of claim 11, wherein the reaction utilizes a catalyst.

15. The method of claim 11, wherein the reaction utilizes copper (I) as a catalyst.

16. The method of any of claim 11, further comprising:
reacting an azide-functionalized material with the alkyne functionalized material present on a substrate to form a second layer.

17. The method of claim 11, further comprising three or more layers wherein each layer is formed by alternating alkyne-functionalized material and azide-functionalized material, wherein the first layer is coupled to the substrate, and each successive layer is coupled to an immediately preceding layer.

18. The layered structure made by claim 11.

19. The use of the layered structure of claim 18 for catalysis.

20. The use of the layered structure of claim 18 for separating at least a first portion of a combination of materials from a second portion of the combination of materials.
